(19) United States
(12) Patent Application Publication
(10) Pub. No.: US 2008/0151853 A1
(43) Pub. Date: Jun. 26, 2008

(54) Data sequence structure and transmission method

(75) Inventors: Kari Pajukoski, Oulu (FI); Esa Tiirola, Kempele (FI)

Correspondence Address: SQUIRE, SANDERS & DEMPSEY L.L.P., 8000 TOWERS CRESCENT DRIVE, 14TH FLOOR, VIENNA, VA, 22182-2700, US

(73) Assignee: Nokia Corporation

(21) Appl. No.: 11/978,667

(22) Filed: Oct. 30, 2007

(30) Foreign Application Priority Data
Oct. 31, 2006 (FI) 20065689

(51) Int. Cl. H04B 7/216

(52) U.S. Cl. 370/342

(57) ABSTRACT

There is provided a data sequence structure for an uplink control information single carrier signal, comprising: a first code word and a second code word each corresponding to at least one type of uplink control information; a plurality of data units included in the first and the second code-words; a similar sequence of pilot units included in both the first and the second code word. The first and the second code word having a maximum Euclidean distance between the data units, and both the first and the second code word having the form of a CAZAC sequence.

### FIELD

The invention relates to a data sequence structure, a data transmission method, a module, a transmitter, a receiver, and a computer-readable distribution medium.

### BACKGROUND

Future 3.9G systems represent a revolutionary path of future cellular systems based on 3GPP standards. It is presumed that 3.9G will have both new radio access scheme and new radio access network (RAN) architecture. SC-FDMA (single carrier frequency division multiple access) technique is among the most probable radio access technologies for 3.9G uplink (UL). Faster and more efficient technology is currently being developed in the evolution of uplink transmission, for example in the uplink part of UTRAN LTE (UMTS terrestrial radio access network long term evolution). One of the possible future 3.9G uplink transmission schemes is based on low-PAPR (peak-to average power ratio) SF-FDMA (single carrier frequency division multiple access) with cyclic prefix to achieve uplink inter-user orthogonality and to enable efficient frequency-domain equalization.

FIG. 1 illustrates an example of a known sub-frame format for 3GPP LTE uplink. One of the drawbacks of a single carrier uplink transmission of a pilot and data is that the pilot and data cannot be included into the same block. As a consequence of that there are two blocks reserved for a pilot signal (SB1, SB2) and six blocks for a data signal (LB1-LB6) in the current sub-frame format. Another single carrier limitation is the fact that the adjustment of the ratio between the transmission power of the pilot and data is very limited due to low PAPR requirements.

Known solutions for simultaneous pilot and data transmission include separated FFT (Fast Fourier transform) for both the pilot and the data. A problem related to multiple FFT-based solutions is an increased PAR (peak-to average ratio), because the signal is no longer a single carrier signal.

Another solution for a single-block uplink data transmission in the LTE system has been presented in the document “ACK/NACK Transmission without Reference Signals Overhead in E-UTRA uplink”, 3GPP TSG RAN WG1#46 bis, Seoul, Korea, 09-13 October, 2006. In this solution, ACK/NACK (acknowledgement/negative acknowledgement) transmission is based on non-coherent sequence modulation that does not contain any reference signals. However, a well-known problem related to non-coherent modulation as compared to coherent modulation is the performance degradation.

Further, a TDM (time-division multiplexing) based solution has been proposed in the document “Multiplexing and Link Analysis of CQI Channel in UL”, 3GPP TSG RAN1 LTE, Cannes, France, 27-30 Jun., 2006. In this TDM-based solution, a long block is split into two short blocks allocable for control and pilot transmission. A problem with this is an increased CP (cyclic prefix) overhead because of the increased number of blocks.

Because of the foregoing reasons, there is a need to consider improvements for data transmission of uplink control information single carrier signals.

### BRIEF DESCRIPTION OF THE INVENTION

An object of the invention is to provide an improved data sequence structure, an improved data transmission method, an improved module, an improved transmitter, an improved receiver, and an improved computer-readable distribution medium.

According to an aspect of the invention, there is provided a data sequence structure for an uplink control information single carrier signal, comprising: a first code word and a second code word each corresponding to at least one type of uplink control information; a plurality of data units included in the first and the second code word; a similar sequence of pilot units included in both the first and the second code word, the first and the second code word having a maximum Euclidean distance between the data units, and both the first and the second code words having the form of a CAZAC sequence.

According to another aspect of the invention, there is provided a data transmission method, comprising: providing a data sequence structure for an uplink control information single carrier signal; providing in the data sequence structure a first code word and a second code word each corresponding to at least one type of uplink control information; providing a plurality of data units included in the first and the second code word; providing a similar sequence of pilot units included in both the first and the second code word, and arranging the first and the second code word to have a maximum Euclidean distance between the data units, and both the first and the second code word to have the form of a CAZAC sequence.

According to another aspect of the invention, there is provided a module for providing a data sequence structure for an uplink control information single carrier signal. The module comprises: a processing unit for including into the data sequence structure a first code word and a second code word, each corresponding to at least one type of uplink control information; a processing unit for including a plurality of data units to the first and the second code words; a processing unit for including a similar sequence of pilot units to both the first and the second code word; a processing unit for providing a maximum Euclidean distance between the data units of the first and the second code word; and a processing unit for providing the form of a CAZAC sequence for both the first and the second code word.

According to another aspect of the invention, there is provided a transmitter comprising one or more transmitter modules as claimed in claim 15. The transmitter comprises: a transmitter unit for transmitting at least one of: the first code word and the second code word in an uplink control information single carrier signal.

According to another aspect of the invention, there is provided a receiver comprising a receiver unit for receiving at least one of: the first code word and the second code word from a transmitter according to claim 22 in an uplink control information single carrier signal.

According to another aspect of the invention, there is provided a computer-readable distribution medium encoding a computer program of instructions for executing a computer process for data transmission. The process comprises: providing a data sequence structure for an uplink control information single carrier signal; providing in the data sequence structure a first code word and a second code word, each corresponding to at least one type of uplink control information; providing a plurality of data units included in the first and the second code word; providing a similar sequence of pilot units included in both the first and the second code word; arranging the first and the second code word to have a maximum Euclidean distance between the data units, and both the first and the second code word to have the form of a CAZAC sequence.

According to another aspect of the invention, there is provided a module for providing a data sequence structure for an uplink control information single carrier signal, comprising: processing means for including into the data sequence structure a first code word and a second code word, each corresponding to at least one type of uplink control information; processing means for including a plurality of data units into the first and the second code word; processing means for including a similar sequence of pilot units to both the first and the second code word; processing means for providing a maximum Euclidean distance between the data units of the first and the second code word; and processing means for providing the form of a CAZAC sequence for both the first and the second code word.

The invention provides several advantages.

Low PAR properties of a single carrier transmission can be maintained. Very fast uplink data detection is enabled since the pilot and the data can be included in the same block. Block-based frequency hopping is enabled. Further, coherent detection of pilot and data can be supported.

### LIST OF DRAWINGS

In the following, the invention will be described in greater detail with reference to the embodiments and the accompanying drawings, in which

FIG. 1 illustrates an example of a known sub-frame format;

FIG. 2 shows an example of a radio system;

FIG. 3 illustrates another example of a radio system;

FIG. 4 illustrates the structure of a transmitter structure;

FIG. 5 illustrates an embodiment of a data sequence structure; and

FIG. 6 illustrates an example of a transmission method.

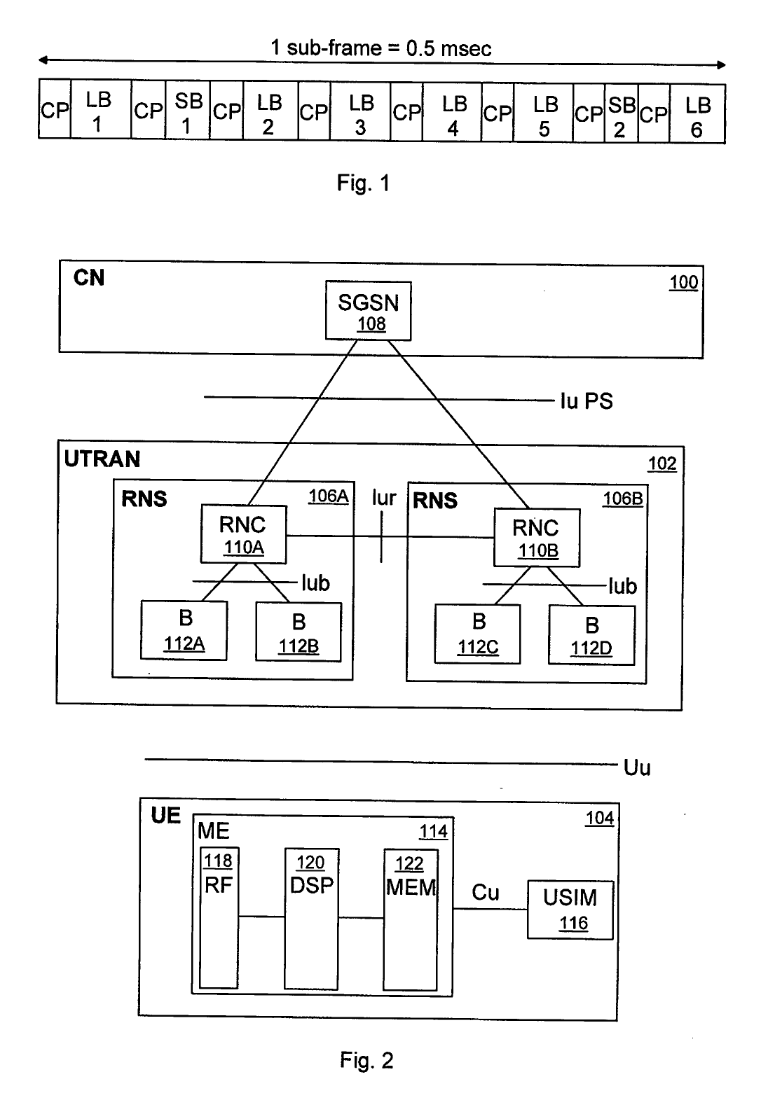

### DESCRIPTION OF EMBODIMENTS

FIG. 2 illustrates an example of a radio system to which the pre-sent solution may be applied. Below, embodiments of the invention will be described using the UMTS (Universal Mobile Telecommunications System) as an example of the wireless telecommunications system. The invention may, however, be applied to any current or future wireless telecommunications systems that support SC-FDMA. The structure and the functions of such a wireless telecommunications system and those of the associated network elements are only described when relevant to the invention.

The wireless telecommunications system may be divided into a core network (CN) 100, a UMTS terrestrial radio access network (UTRAN) 102, and user equipment (UE) 104. The core network 100 and the UTRAN 102 form a network infrastructure of the wireless telecommunications system.

The UTRAN 102 is typically implemented with wideband code division multiple access (WCDMA) radio access technology.

The core network 100 includes a serving GPRS support node (SGSN) 108 connected to the UTRAN 102 over an lu PS interface. The SGSN 108 represents the center point of the packet-switched domain of the core network 100. The main task of the SGSN 108 is to transmit packets to the user equipment 104 and to receive packets from the user equipment 104 by using the UTRAN 102. The SGSN 108 may contain subscriber and location information related to the user equipment 104.

The UTRAN 102 includes radio network sub-systems (RNS) 106A, 106B, each of which includes at least one radio network controller (RNC) 110A, 110B and nodes B 112A, 112B, 112C, 112D.

Some functions of the radio network controller 110A, 110B may be implemented with a digital signal processor, memory, and computer programs for executing computer processes. The basic structure and the operation of the radio network controller 110A, 110B are known to one skilled in the art and only the details relevant to the present solution are discussed in detail.

The node B 112A, 112B, 112C, 112D implements a Uu interface, through which the user equipment 104 may access the network infrastructure. Some functions of the base station 112A, 112B, 112C, 112D may be implemented with a digital signal processor, memory, and computer programs for executing computer processes. The basic structure and operation of the base station 112A, 112B, 112C, 112D are known to one skilled in the art and only the details relevant to the present solution are discussed in detail.

The user equipment 104 may include two parts: mobile equipment (ME) 114 and a UMTS subscriber identity module (USIM) 116. The mobile equipment 114 typically includes radio frequency parts (RF) 118 for providing the Uu interface. The user equipment 104 further includes a digital signal processor 120, memory 122, and computer programs for executing computer processes. The user equipment 104 may further comprise an antenna, a user interface, and a battery not shown in FIG. 2.

The USIM 116 comprises user-related information and information related to information security in particular, such as an encryption algorithm.

The basic structure and operation of the user equipment 104 are known to one skilled in the art and only the details relevant to the present solution are discussed in detail.

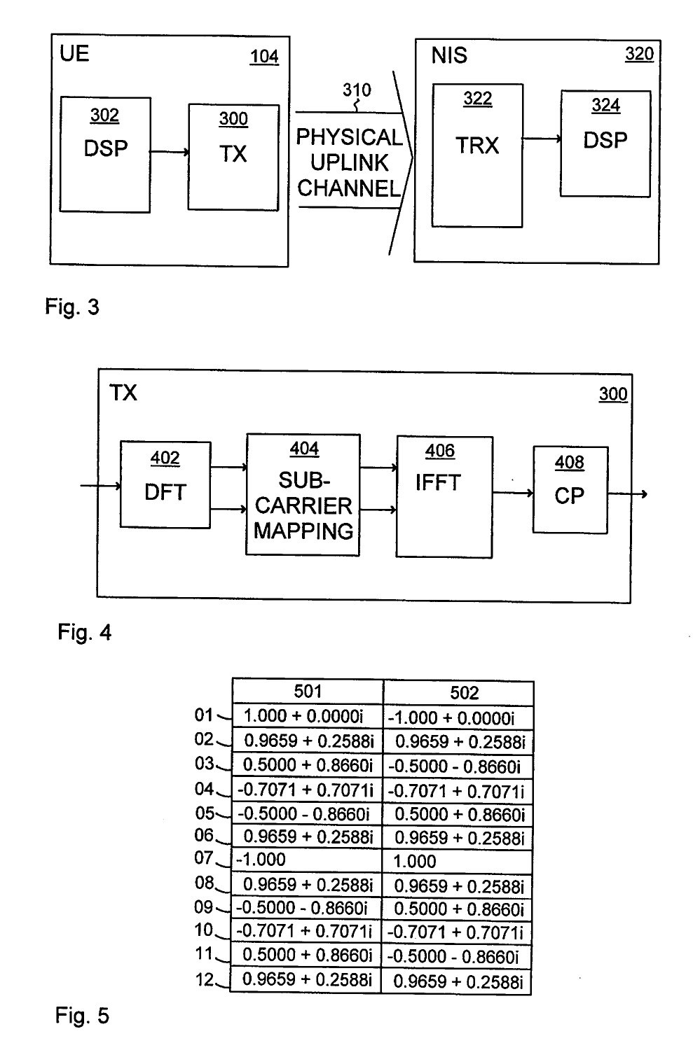

FIG. 3 shows another example of a radio system. The radio system comprises a network infrastructure (NIS) 320 and a user terminal (UE) 104. The user terminal 104 may be connected to the network infrastructure 320 over an uplink physical data channel, such as a DPDCH (Dedicated Physical Data channel) defined in the 3GPP specification.

In FIG. 3, only one user terminal 104 is shown. However, it is assumed that there can be several user terminals 104 that share a common frequency band for communicating with the network infrastructure 320. The user terminals 104 may be scattered throughout the coverage area of the network infrastructure 320, which may be divided into cells with each cell being associated with a Node B. The user terminals within a cell may be served by the Node B associated with the cell. If a user terminal resides at the edge of a cell, the user terminal may be served by one or more nodes B associated with adjacent cells.

The radio system may employ several data modulation schemes in order to transfer data between user terminals 104 and network infrastructure 320 with variable data rates. The radio system may employ, for example, quadrature phase shift keying (QPSK) and quadrature amplitude modulation (QAM) modulation schemes. Several coding schemes may also be implemented with different effective code rates (ECR). For example, when a communication link between a user terminal 104 and network infrastructure 320 is of low quality, strong coding may be used in order to ensure reliable data transfer. On the other hand, under a high quality communication link lighter coding may be used to provide high data rate communications.

The user terminal 104 comprises a signal-processing unit 302 for controlling the functions of the user terminal, and a transmitter unit 300 for communicating with network infrastructure 320. The network infrastructure 320 comprises a transmitting/receiving unit 322, which carries out channel encoding of transmission signals, converts them from the baseband to the transmission frequency band and modulates and amplifies the transmission signals. The signal-processing unit DSP 324 controls the operation of the network element and evaluates signals received via the transmitting/receiving unit 322.

The user terminal 104 is required to transmit several control signaling bits related to downlink data transmission to the network infrastructure 320 via the uplink channel 310. For example, ACK/NACK UL transmission corresponding to each received downlink transport block, and channel quality indicators (CQI) may be required in the uplink direction.

FIG. 4 shows the structure of a transmitter 300 of a user terminal 104 for a SC-FDMA system. An example of frequency-domain generation of a transmission signal, sometimes known as discrete Fourier transform (DFT)-spread OFDMA, is illustrated.

The symbols transmitted on a sub-carrier are first processed in the DFT block 402. In an embodiment, using the DFT block 402 is, however, not necessary. The sub-carrier mapping block 404 determines which part of the spectrum is used for transmission by inserting a suitable number of zeros. L-1 zeros are inserted between each DFT block 402 output sample. The inserted CP in block 408 depends on the output of the Inverse Fast Fourier Transform (IFFT) 406.

In an embodiment, a special data sequence structure is created in a module of the user terminal for use in an uplink control information single carrier signal. The data sequence structure includes a first code word and a second code word, each corresponding to at least one type of uplink control information. Further, a plurality of data units is included in the first and the second code word, and a similar sequence of pilot units are included in both the first and the second code word. The first and the second code word also have a maximum Euclidean distance between the data units, and both the first and the second code words have the form of a CAZAC (Constant Amplitude Zero AutoCorrelation) sequence.

An example of a data sequence structure is illustrated in FIG. 5. The proposed data sequence could be described in a matrix, the elements of which may be based on the structure illustrated in FIG. 5.

In an embodiment, the first and the second code word can be coded in such a way that the first column of a matrix, i.e. 501 of FIG. 5, is transmitted in case of an ACK and the second column of the matrix, i.e. 502 of FIG. 5, is transmitted in case of a NACK, respectively. A similar sequence of pilot units is included in both the first and the second code word, i.e. in the rows 2, 4, 6, 8, 10, 12 of FIG. 5, for utilizing a coherent detection on the receiver side.

The data units are included in the rows 1, 3, 5, 7, 9, 11 of FIG. 5, and from the example it can be seen that there is an optimal Euclidean distance between data units of the two code words corresponding to ACK and NACK, for example. This can be seen when comparing the two columns of the matrix corresponding to the rows 1, 3, 5, 7, 9, 11. The maximum Euclidean distance between the data units improves the detection of the transmitted single carrier signal. Further, both the first and the second code words in columns 501 and 502 have the form of a CAZAC sequence for achieving perfect autocorrelation properties for the transmitted signal. The CAZAC sequences are described for example in “Multi Carrier and Spread Spectrum Systems,” Fazel K., Keiser S, John Wiley and Sons, 2003.

An example of CAZAC sequences can be given as follows. Let L be a positive integer, and let k be any number that is relatively prime with L. Then nth entry of the kth Zadoff-Chu CAZAC sequence can be given as follows:

$${c}_{k} ( n ) = exp [ \frac{j2π k}{L} ( n + n \frac{n + 1}{2} ) ]$$

if L is odd, and

$${c}_{k} ( n ) = exp [ \frac{j2π k}{L} ( n + \frac{{n}^{2}}{2} ) ]$$

if L is even.
The set of Zadoff-Chu CAZAC sequences has the following properties: constant magnitude, zero autocorrelation, flat frequency domain response, and low constant magnitude cross-correlation when L is a prime number.

In an embodiment, the similar elements not dependent on the transmitted information can be found from both of the first and the second code word. The embodiments are also based on FDM multiplexing between pilot and data, thus advantageously maintaining low PAR properties of a single carrier signal. The special data sequences contain the pilot and the data in the same sequence, thereby supporting coherent detection.

In an embodiment, the length of the first code word and the length of the second code word correspond to the size of a single physical block of an uplink control information single carrier signal.

In an embodiment, the size of the IFFT block 406 corresponds to the system bandwidth, and the size of the DFT block 402 corresponds to the size of the used bandwidth.

In an embodiment, the data sequence structure is in the form of a matrix comprising a first column 501 corresponding to the first code word, a second column 502 corresponding to the second code word, and a number of rows for the data units and the pilot units 01-12. In an embodiment, the total number of rows in the matrix is twelve, the rows indexed with odd numbers being for the data units and the rows indexed with even numbers for the pilot units.

In an embodiment, the first code word includes a code for an acknowledgement signal, and the second code word includes a code for a negative acknowledgement signal.

In an embodiment, the data sequence structure comprises multiple pairs of the first and the second code words for simultaneous use by multiple user terminals, wherein the multiple pairs of the first and the second code words are based on cyclic-shifted CAZAC sequences. Thus, it is possible to have multiple pairs of code having the advantageous properties discussed above. These pairs are based on cyclic-shifted CAZAC sequences, and can be used, for example, for multiplexing ACK/NACK from multiple user terminals into the same resource. The multiple code pairs will maintain the orthogonality properties also in frequency selective channels with respect to both pilot signals (rows 2, 4, 6, 8, 10, 12) and data signals (rows 1, 3, 5, 7, 9, 11). Because the cyclic-shifted CAZAC sequence pairs are orthogonal, cross-correlation between them is zero.

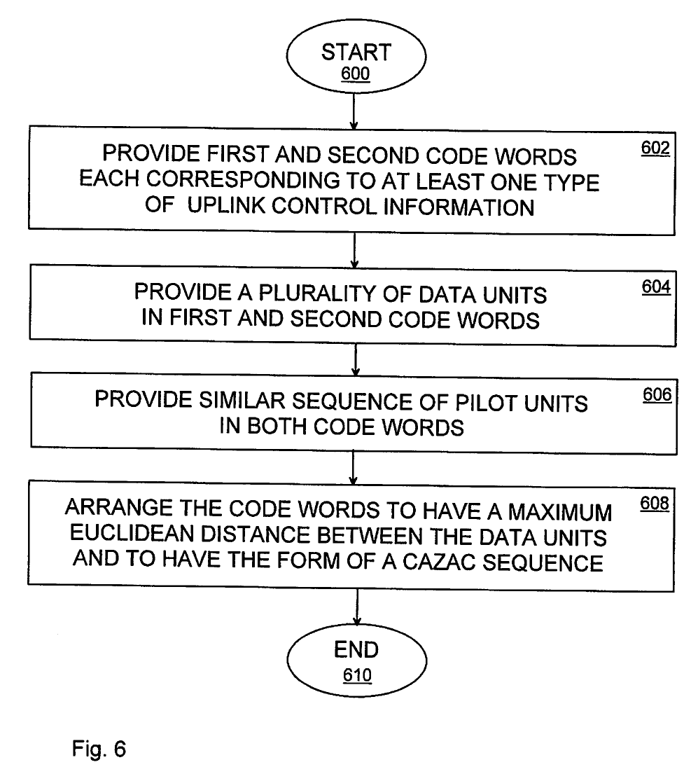

FIG. 6 illustrates an example of a transmission method. The method starts in 600. In 602, a first code word and a second code word each corresponding to at least one type of uplink control information is provided in the data sequence structure. In 604, a plurality of data units is included in the first and the second code word. In 606, a similar sequence of pilot units is included in both the first and the second code word. In 608, the first and the second code word are arranged to have a maximum Euclidean distance between the data units, and both the first and the second code word are arranged to have the form of a CAZAC sequence. Finally, the suitable code word can be transmitted to the network infrastructure. The method ends in 610.

The embodiments of the invention may be realized in a transmitter, comprising a module for providing a data sequence structure for an uplink control information single carrier signal. The module may be configured to perform at least some of the steps described in connection with the flowchart of FIG. 6 and in connection with FIGS. 3, 4, and 5. The embodiments may be implemented as a computer program comprising instructions for executing a computer process for data transmission.

The computer program may be stored on a computer-readable distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but can be modified in several ways within the scope of the appended claims.

1. A data sequence structure, comprising:
a first code word and a second code word, each corresponding to at least one type of uplink control information;
a plurality of data units included in the first and the second code word;
a similar sequence of pilot units included in both the first and the second code word,
the first and the second code word having a maximum Euclidean distance between the data units, and both the first and the second code word having the form of a CAZAC sequence.

2. The data sequence structure of claim 1, wherein the length of the first code word and the length of the second code word correspond to the size of a single physical block of an uplink control information single carrier signal.

3. The data sequence structure of claim 1, wherein the data sequence structure is in the form of a matrix comprising a first column corresponding to the first code word, a second column corresponding to the second code word, and a number of rows for the data units and the pilot units.

4. The data sequence structure of claim 3, wherein the number of rows is twelve, the rows indexed with odd numbers being for the data units and the rows indexed with even numbers for the pilot units.

5. The data sequence structure of claim 1, wherein the first code word includes a code for an acknowledgement signal, and the second code word includes a code for a negative acknowledgement signal.

6. The data sequence structure of claim 1, comprising multiple pairs of the first and the second code words for simultaneous use by multiple user terminals, wherein the multiple pairs of the first and the second code words are based on cyclic-shifted CAZAC sequences.

7. A method, comprising:
providing a data sequence structure for an uplink control information single carrier signal;
providing in the data sequence structure a first code word and a second code word, each corresponding to at least one type of uplink control information;
providing a plurality of data units included in the first and the second code word;
providing a similar sequence of pilot units included in both the first and the second code word; and
arranging the first and the second code word to have a maximum Euclidean distance between the data units, and both the first and the second code word to have the form of a CAZAC sequence.

8. The method of claim 7, further comprising: arranging the length of the first code word and the length of the second code word to correspond to the size of a single physical block of an uplink control information single carrier signal.

9. The method of claim 7, further comprising: forming the data sequence structure in the form of a matrix comprising a first column corresponding to the first code word, a second column corresponding to the second code word, and a number of rows for the data units and the pilot units.

10. The method of claim 9, wherein the number of rows is twelve, the rows indexed with odd numbers being for the data units and the rows indexed with even numbers for the pilot units.

11. The method of claim 7, further comprising: providing a code for an acknowledgement signal to the first code word, and providing a code for a negative acknowledgement signal to the second code word.

12. The method of claim 7, further comprising: providing multiple pairs of the first and the second code words for simultaneous use by multiple user terminals, wherein the multiple pairs of the first and the second code words are based on cyclic-shifted CAZAC sequences.

13. An apparatus, comprising:
a processing unit for including into a data sequence structure a first code word and a second code word, each corresponding to at least one type of uplink control information, wherein the data sequence structure is for an uplink control information single carrier signal;
a processing unit for including a plurality of data units to the first and the second code words;
a processing unit for including a similar sequence of pilot units to both the first and the second code word;
a processing unit for providing a maximum Euclidean distance between the data units of the first and the second code word; and
a processing unit for providing the form of a CAZAC sequence for both the first and the second code word.

14. The apparatus of claim 13, wherein the length of the first code word and the length of the second code word correspond to the size of a single physical block of an uplink control information single carrier signal.

15. The apparatus of claim 13, wherein the data sequence structure is in the form of a matrix comprising a first column corresponding to the first code word, a second column corresponding to the second code word, and a number of rows for the data units and the pilot units.

16. The apparatus of claim 15, wherein the number of rows is twelve, the rows indexed with odd numbers being for the data units and the rows indexed with even numbers for the pilot units.

17. The apparatus of claim 13, wherein the first code word includes a code for an acknowledgement signal, and the second code word includes a code for a negative acknowledgement signal.

18. The apparatus of claim 13, comprising multiple pairs of the first and the second code words for simultaneous use by multiple user terminals, wherein the multiple pairs of the first and the second code words are based on cyclic-shifted CAZAC sequences.

19. A computer-readable distribution medium encoding a computer program of instructions for executing a computer process for data transmission, the process comprising:
providing a data sequence structure for an uplink control information single carrier signal;
providing, in the data sequence structure, a first code word and a second code word, each corresponding to at least one type of uplink control information;
providing a plurality of data units included in the first and the second code word;
providing a similar sequence of pilot units included in both the first and the second code word; and
arranging the first and the second code word to have a maximum Euclidean distance between the data units, and both the first and the second code word to have the form of a CAZAC sequence.

20. The computer-readable distribution medium of claim 19, the process further comprising: arranging the length of the first code word and the length of the second code word to correspond to the size of a single physical block of an uplink control information single carrier signal.

21. The computer-readable distribution medium of claim 19, the distribution medium including at least one of the following media: a computer readable medium, a program storage medium, a record medium, a computer readable memory, a computer readable software distribution package, a computer readable signal, a computer readable telecommunications signal, and a computer readable compressed software package.

22. An apparatus, comprising:
processing means for including to the data sequence structure a first code word and a second code word, each corresponding to at least one type of uplink control information, wherein the data sequence structure is for an uplink control information single carrier signal;
processing means for including a plurality of data units into the first and the second code word;
processing means for including a similar sequence of pilot units to both the first and the second code word;
processing means for providing a maximum Euclidean distance between the data units of first and the second code word; and
processing means for providing the form of a CAZAC sequence for both the first and the second code word.

23. The apparatus of claim 22, wherein the length of the first code word and the length of the second code word correspond to the size of a single physical block of an uplink control information single carrier signal.
